(19) United States
(12) Patent Application Publication
(10) Pub. No.: US 2005/0234917 A1
(43) Pub. Date: Oct. 20, 2005

(54) Method and system for connecting publishers with subscribers through an intermediate server and a user installed application

(76) Inventors: Roen Prince Branham, Brooklyn, NY (US); Victor Jason McDaniel, Dix Hillis, NY (US)

Correspondence Address: Roen Branham, 1252 East 38th Street, Brooklyn, NY, 11210, US

(21) Appl. No.: 10/820,940

(22) Filed: Apr. 9, 2004

(51) Int. Cl. G06F 7/00

(52) U.S. Cl. 707/10

(57) ABSTRACT

The present invention provides a method and system for connecting publishers with subscribers by using a middleman structure in which the publisher never directly contacts the user but submits publications to an intermediate server. The publication subscriber uses an application installed on a client device to connect to the middleman in order to see if the publisher has submitted a publication for current application users subscribed to said publisher. Whenever the subscriber application updates, the application individually links to all existing new publications that said application user has registered for. In the embodiment of a subscription management system of the invention, several modules have been communicatively coupled to provide a complete and reliable system to subscribers with direct access to only publications they subscribe to without Spam and to publishers for tracking how many subscribers have received and viewed the publication, while keeping a Publisher informed and prepared at all times, allowing subscribers to receive only publications that they subscribe to themselves.

### TECHNICAL FIELD

Disclosed embodiments herein relate generally to electronic publications, and more particularly to value-added electronic publication services and implementation thereof using an intermediate server accessible by publishers and an application installed by publisher subscribers.

### BACKGROUND

The adoption of the Internet as a medium to share and transfer information has occurred at an unprecedented pace. Of routine computer users, most now register or soon will register for an online publication through an e-mail address. E-mail offers unparalleled convenience of written communication however the threat of SPAM/junk mail can destroy this benefit for legitimate publishers by bombarding individuals with unwanted unsolicited messages.

With the widespread proliferation of unwanted junk e-mail, or “Spam”, Currently, of the hundreds of millions of e-mail messages sent each day about 40% of those messages may be expected to be unwanted junk e-mail. Various companies have addressed the problem of junk e-mail by providing e-mail filtering software that attempts to identify and discard junk e-mail based on preset and “intelligent-learning” rules. Typically, such software resides on a destination e-mail server or the end users PC. Such a solution does not resolve the problem of Junk Email and oftentimes blocks legitimate and anticipated email from reaching the intended recipient. The complexity and sheer quantity of today's Junk Email is placing significant strain on the ability of Internet based publishers to successfully transmit their publications to registered members through email.

For example, if a person has an email address and on a daily basis receives 100 pieces of unwanted junk mail, that person may no longer concentrate on email but skim through and possibly delete a valuable email that they specifically requested such as a receipt of purchase or an answer to a question posted in a forum. Another example would be where an ISP or email provider incorporates an Anti-SPAM software which blocks a potentially valuable email from ever reaching a persons email inbox based on content filters; IP address black lists, etc.

Neither ISPs or email providers are well positioned to offer a complete solution to the electronic publication problem. ISPs are primarily focused on new customer acquisition/branding and have deemed Anti-SPAM software as the correct solution. In the case of email providers, providers appear to agree with ISP's and continue to implement Anti-SPAM software as the correct solution. End user's/PC owners use these software's for a lack of a better solution.

Accordingly, a need exists for a scalable, transparent solution for legitimate Publishers to no longer suffer from the junk e-mail backlash. This invention provides a non-biased and anonymous application, which will allow only publishers that the application user registers for to contact them through the combination of the intermediate server and the user installed application.

### BRIEF SUMMARY

This disclosure, generally speaking, provides for an Electronic Subscription System in which individual, configurable user applications are used to route the application user to a publication that has been submitted by a publisher and registered for by the application user.

The Electronic Subscription System provides publishers with a means of reaching 100% of their subscription base without worrying about email SPAM filters erroneously blocking their publication based on content, IP address, or the publishers ISP.

The Electronic Subscription System allows the application user to maneuver through the World Wide Web, register for specific publications of their choice and only receive publications that they have actively registered for.

A registered publisher has the ability to submit a publication using a web based interface hosted on the intermediate server whereby all registered application users will be automatically updated by the application at set intervals to reflect a new publication from said publisher.

The Electronic Subscription System does not use email to deliver a publication but instead uses an application installed by the subscriber, which contacts the intermediate server and verifies whether or not there are publications available in which the subscriber has registered for.

The application then displays each publication as a hyperlink within the application and, upon activation of the hyperlink by the application user, the application directs the user to the intermediate server.

Upon reaching the intermediate server a website module is enacted which registers in one or more storage facilities that the user has visited the specified publication.

After the storage facility has been updated the user is then forwarded to the stored location of the specified publication.

A publication, instead of being sent through email and possibly blocked due to content or IP Black lists, is posted to a user-accessible web site where it is kept for a period of time. A subscriber therefore has an opportunity to receive notification of the location of the publication through the installed application and visit the publication at the subscriber's convenience.

The ease of installing the application enables users to manage their subscription status for any publication without requiring any significant effort on the part of the subscriber. The application user can easily register for or Unsubscribe from any publication through the application itself and does not require the user to visit any website or await any action by the publisher or the publishers website.

This invention allows full anonymity for the end user by using “Pull technology” whereby the application user connects to the intermediate server and pulls the information submitted by a publisher related to the user rather than the intermediate server keeping tabs on the user and pushing the information to the user. Given the nature of dynamic IP addresses coupled with the pull technology used in this invention, it is impossible for any publisher or any outside body to send any messages to a user of this invention without the users express permission.

### BRIEF DESCRIPTION OF THE DRAWINGS

The present invention may be further understood from the following description in conjunction with the appended drawings. It is emphasized that various features may not be drawn to scale. In fact, the dimensions of various features may be arbitrarily increased or reduced for clarity of discussion. In addition, it is emphasized that some components may not be illustrated for clarity of discussion. In the drawings:

FIG. 1 is a screen shot of an example version of the application;

FIG. 2 is a diagram used to show how present email is sent from user to user;

FIG. 3 is a diagram of how a typical publisher currently uses email to transmit a publication;

FIG. 4 is a diagram demonstrating the process necessary for a publisher to complete in order for a publication to be available for viewing by the application users who are registered for said publisher.

FIG. 5 represents the process necessary for a user application to complete in order to retrieve current publications available for the application user.

FIG. 6 represents an example of how the current publication display list can appear on the users screen.

FIG. 7 is a diagram showing how through the use of the subscription manager solution, email is not utilized in the broadcasting of a publication;

FIG. 8 is a screenshot representing the method by which an application user will register for a publisher of choice.

FIG. 9 is a diagram to show the complete path a user travels to view a publication.

FIG. 10 is a diagram to show how the application downloads the publication directly to the users local hardware device for viewing at a later time.

FIG. 11 is a diagram showing how the user application checks the intermediate server to determine the expiration date of all publications and subsequently deletes expired publications from the users local hardware device.

### DETAILED DESCRIPTION

It will be readily understood that the components of the embodiments as generally described and illustrated in the Figures herein could be arranged and designed in a wide variety of different configurations. Thus, the following more detailed description of the embodiments of the methods and apparatus of the present invention, as represented in the Figures, is not intended to limit the scope of the invention, as claimed, but is merely representative of the embodiments of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are shown to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

The details of one or more implementations of the invention are set forth in the accompanying drawings and the description below. Other features and advantages of the invention will become apparent from the description, the drawings, and the claims.

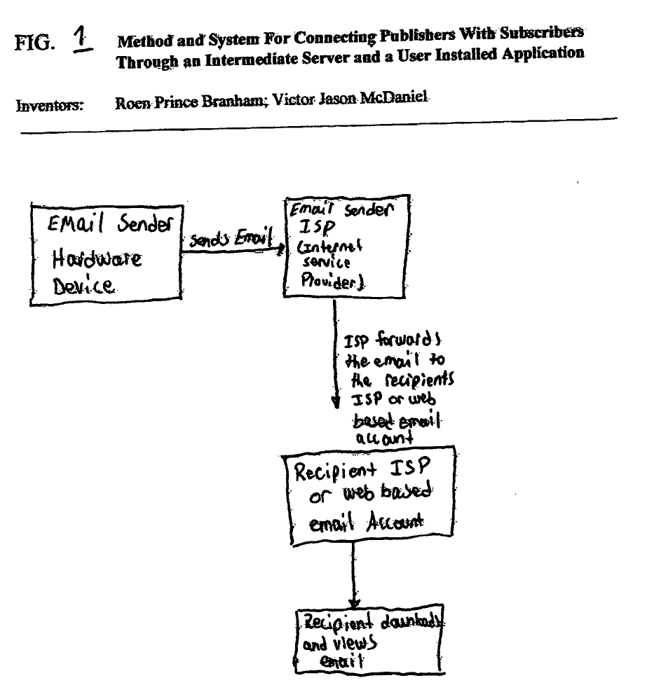

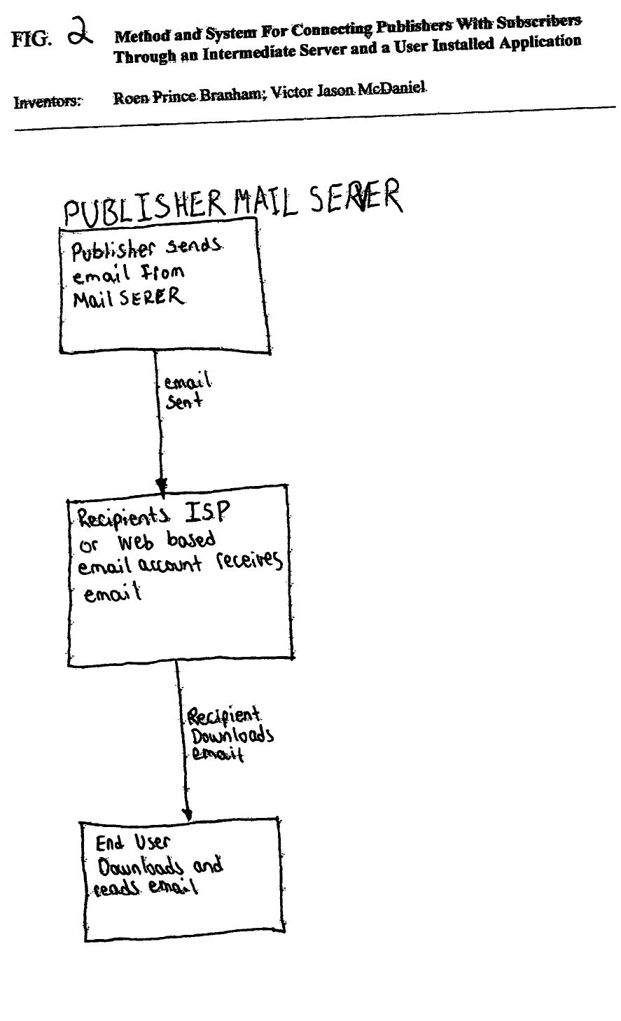

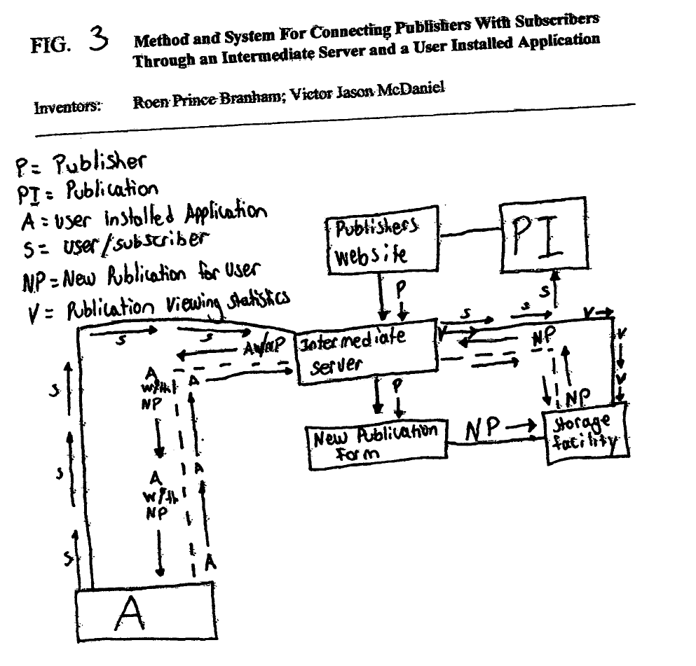

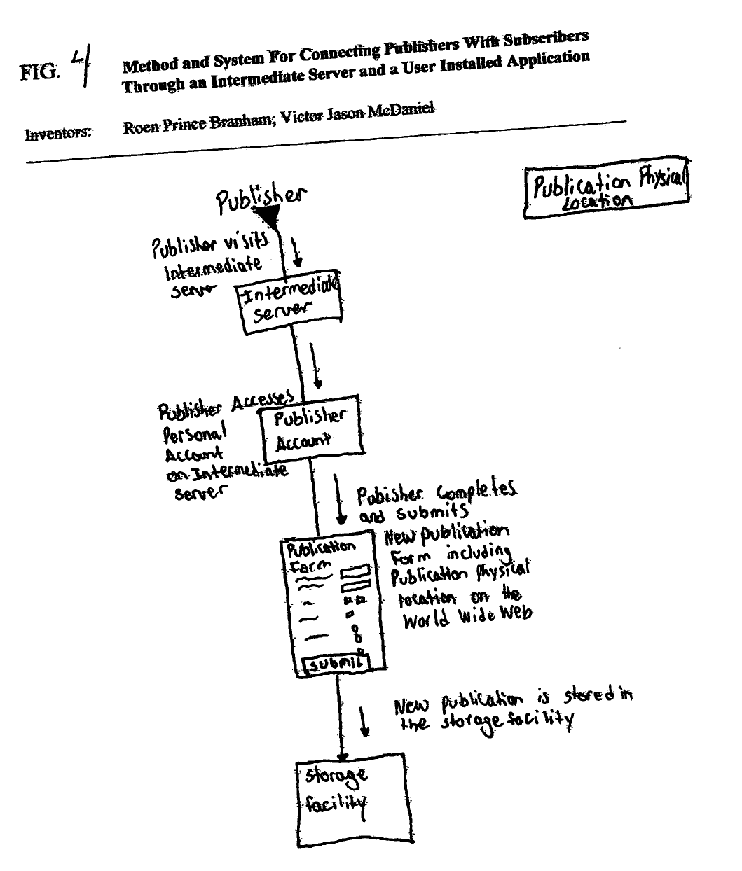

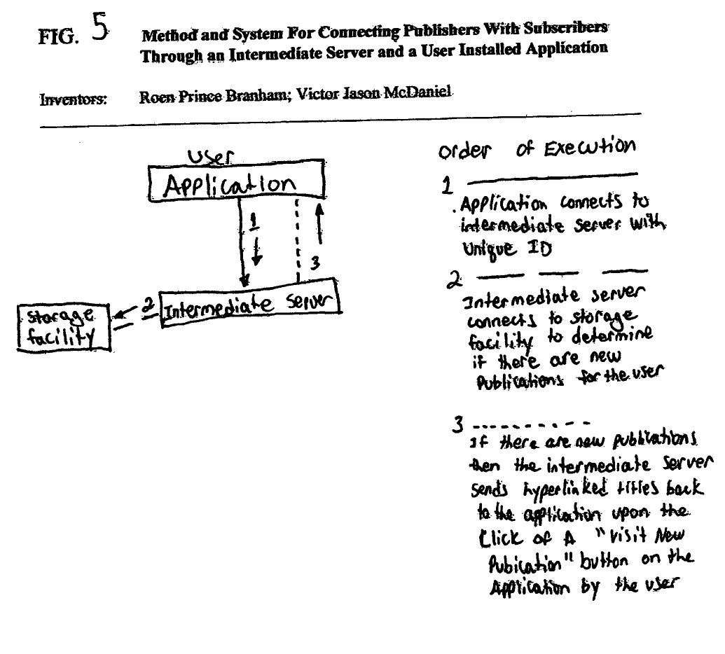

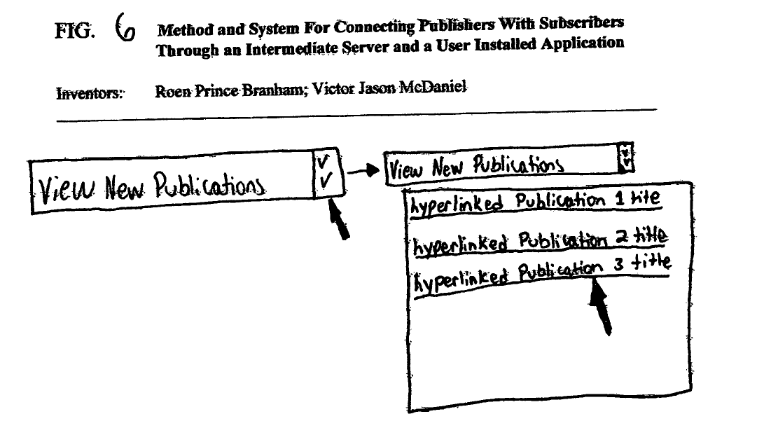

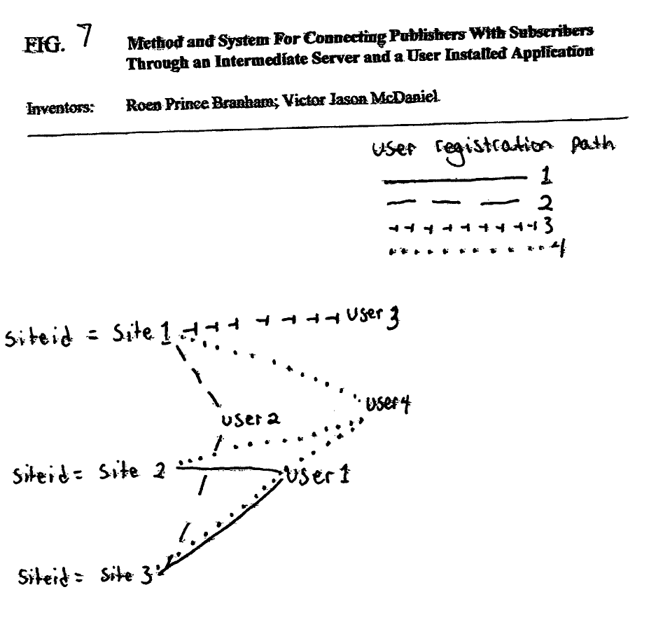

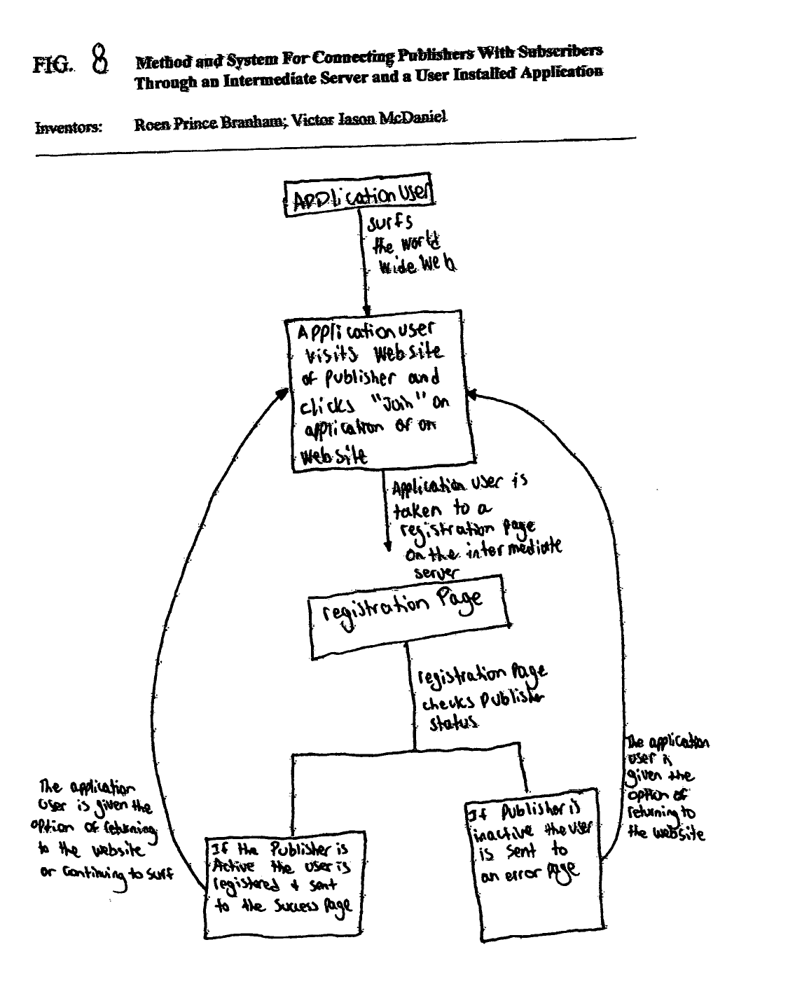

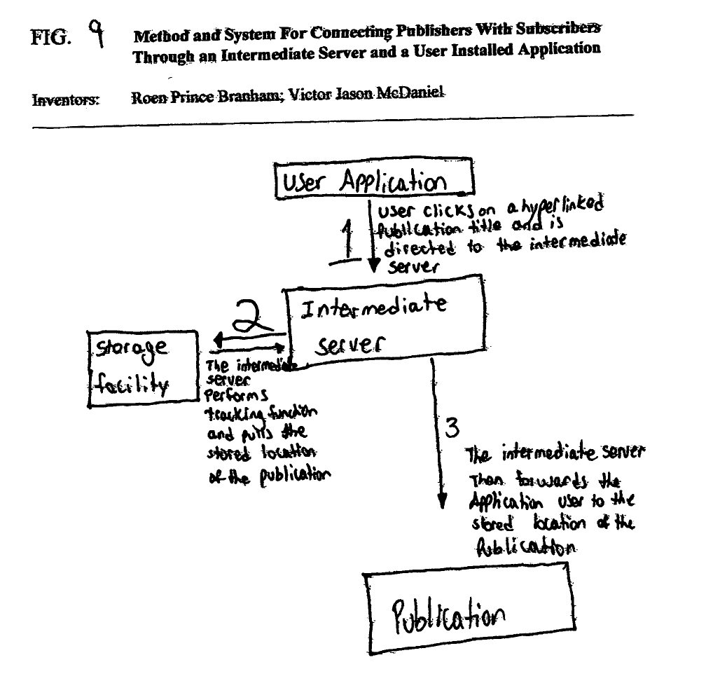

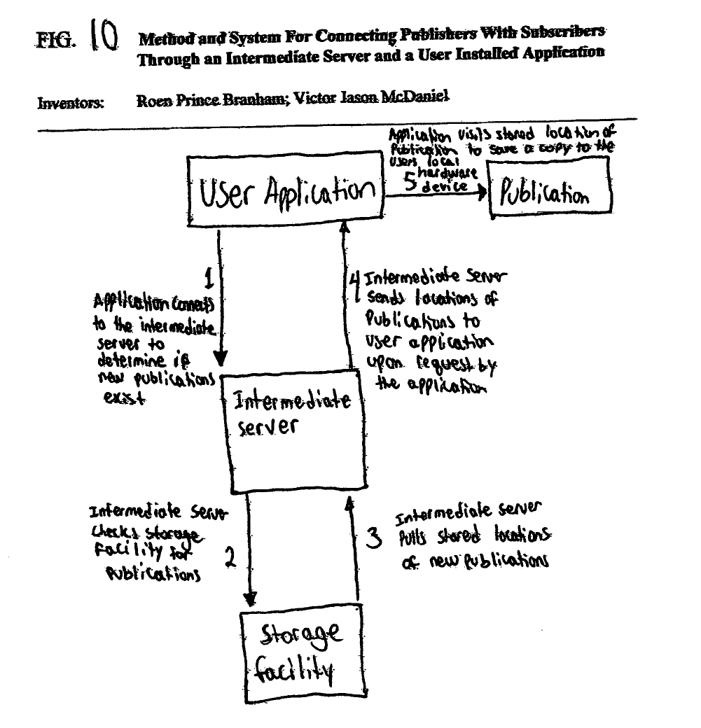

As shown in FIG. 1, the end user has installed an application which contains a unique randomly generated ID to recognize that specific users self determined subscription profile.

As the user maneuvers the World Wide Web and finds publications of interest they are given the opportunity to register for those publications through the installed application (shown in FIG. 5) which uses the users unique ID and a publisher siteid to determine which publication that user wishes to register for. The user must actively click on the “join” button on the application or a join feature on the publisher's web site before they are registered for the specified application.

Upon clicking on the “join” button the application will draw the specified publishers URL/siteid and redirect the user to the intermediate server where it will be determined whether or not the URL/siteid is an active publisher in the central storage facility.

Once the URL or siteid status is determined as active the intermediate server will register the username of the user for the specified publisher. This information is stored in a storage facility along with the users other publication subscriptions. Upon completion of registration the user will be redirected to a web page on the intermediate server where they will have the opportunity to return to the exact page in which they joined the publisher from or continue maneuvering the World Wide Web.

Should the URL/siteid be invalid then the user will be redirected to a web page on the intermediate server where a note will indicate the status of that publisher and direct the user to return to the publishers web site and contact the publisher about the problem.

As the user maneuvers through the World Wide Web the installed application periodically connects to the intermediate server to cheek if any of the publishers, that the user is currently registered with, have submitted publications that the user has yet to view. If there exist new publications the application notifies the user through the use of a new publications alert image as shown in FIG. 6. The new publications alert image uses a color code along with a numerical representation of how many new publications the user has to view.

When there are new publications the user will actively click on a drop down menu on the application in order to view hyperlinks that will direct the user to the specified publication.

The user will need to click on the hyperlinked subject line/title of the publication in the publication menu in order to be directed to the intermediate server for processing.

Upon first clicking on the hyperlink, the user will first be directed to the intermediate server where a website module will be called to update one or more storage facilities to reflect the user having viewed the publication being represented by the hyperlink clicked on.

The intermediate server will then forward the user to the location of the publication stored in the storage facility for viewing.

In order for a publisher to manage their account the publisher will be required to access the intermediate server using their designated username and password. After successfully accessing the intermediate server, the publisher may then submit new publications for users, check viewing statistics, update existing publications, delete old publications and view application user data.

Each publisher will create a new publication in which the present application users, who are registered for said publisher, will be updated to reflect the new publication status and have the ability to visit the publication location for viewing once the user application connects to the intermediate server to update itself.

In order to submit a publication, the publisher must complete anew publication form and submit it to at least one website module to be placed in at least one storage facility. Specific information is required by the publisher for successfully submitting a new publication including location of the publication on the World Wide Web, the title of the publication and an expiration date.

The website module will determine whether this is the first time the user has viewed the specified application or not and update the one of more storage facilities to reflect the status.

New publications can be hosted directly on the intermediate server or hosted by the publisher and have an expiration date determined by the publisher where after the expiration date the publication will no longer be accessible through the intermediate server and will not be reflected in the application users new publications alert.

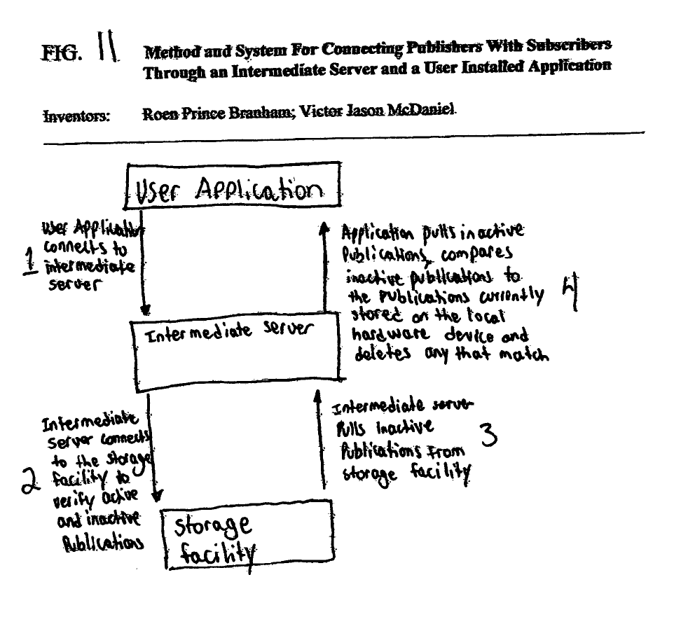

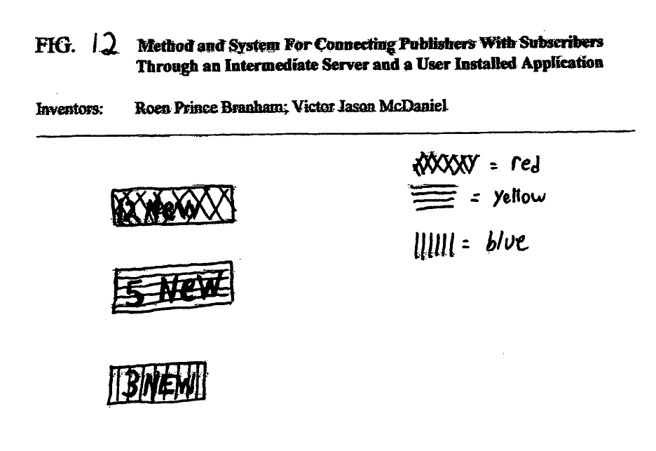

In the event that the user chooses to have the publications downloaded for later viewing the application will follow the path as shown in FIG. 10. The application will pass the users unique ID to the intermediate server at which point the intermediate server will determine which publications are expired and have the application delete them from the Users local hardware device. Upon completion of the expired publication deletion, the intermediate server will determine which new publications are available for download and each new publication link will be accessed by the intermediate server to perform the download process to the users local hardware device.

1. A subscription managing and transferring system accessible by publishers and end users, comprising:
An internet accessible intermediate host server, comprising:
At least one storage facility module adapted to contain information about specific publications that each end user has individually registered for;
A publication module coupled with the storage facility module;
A tracking/reports module communicatively coupled to at least one storage facility module.
A user application used by subscribers to connect to the intermediate host server in order to determine if new publications have been submitted by publishers who the subscriber has registered for, register for new publications, unsubscribe from publishers and manage activities related to the specified users account.
At least one website management module on the intermediate host server communicatively coupled to at least one of the storage facility module or the application, wherein the website management module comprises:
A template based publication creation interface;
A template based publication management interface;
A tracking/reports-checking interface;
At least one storage facility connection module;
At least one user application connection module;
An Internet connection between the host server and the Internet.
A storage facility module communicatively coupled to at least the one of the website module, the tracking module, the campaign module, or the user application, wherein the storage facility module comprises:
A plurality of devices and applications for storing publisher information, the location of publications submitted by a publisher, application user information, and application user tracking statistics.

2. The system of claim 1, wherein the internet accessible host server is configured to carry at least one sequence of instructions for accessing subscription information stored in a storage facility, wherein execution of the at least one sequence of instructions comprises:
Supplying, to an application user, new publication information data elements that are attributes of at least one query by retrieving the information data elements directly from at least one storage facility that contains the information data elements;
Retrieving the one or more information data elements directly from at least one Storage facility;
Displaying data information elements directly in the users application.

3. The system of claim 2, wherein the supplying to the user of the publication information data elements is performed by:
The application retrieving from the intermediate server over the network (Otherwise known as pull technology), data for only those attributes of the at least one query that is requested by the user;
Retrieving the information data elements directly from the at least one storage facility;
Providing the information data elements to a user over a user interface, wherein the user is connected to the server computer over the network.

4. The system of claim 3, wherein a single randomly generated ID is used to identify the application end user and in the determining of current publications submitted by publishers listed in the users subscription account.

5. The system of claim 3, wherein a single randomly generated ID is used by at least one website module for tracking of publication viewing.

6. The system of claim 1, further comprising an active publication module communicatively coupled to at least one of the storage facility module, the tracking/reports module, the website management module or the application, wherein the active publication module comprises all stored publication and is adapted to extract information from at least one of the storage facility module and the tracking/reports module and manipulate the extracted information to provide links to the end users representing unviewed and previously viewed publications.

7. The system of claim 6, wherein the stored publications comprise at least one of a hyperlink to allow connecting the subscriber to a publication submitted by a publisher in which the subscriber has registered.

8. The system of claim 6, wherein the hyperlink used to allow connection by the user to the publication is presented on a display screen adapted for displaying subscriber publications and hen the hyperlink is activated, the display screen switches the display from display one of the present screen to displaying the publication that was submitted to the storage facility by the publisher.

9. The system of claim 7, wherein the stored publications are linked with trackable redirects processed by at least one website module to determine if the user has viewed the publication in the past or not.

10. The system of claim 7, wherein upon determining if the user has viewed the publication in the past the website module updates at least one storage facility to reflect a new view or a repeat view of the publication by the specific user.

11. The system of claim 7, wherein after website module updates the storage facility to reflect viewing statistics, the at least one website module then accesses at least one storage facility to determine the location of the publication and then direct the user to that location.

12. The system of claim 1, wherein the user application has the ability to maintain its own storage facility located on the users hardware device.

13. The system of claim 12, wherein the user application connects to the website module and actively downloads the publication information from the intermediate server to be stored locally for display through the user application from the users hardware device.

14. The system of claim 12, wherein the user application possesses the ability to connect to the intermediate server, access the publication locations, and download the publications directly to a location on the users hardware device for viewing at a later time.

15. The system of claim 12, wherein the user application connects directly to the intermediate server to determine the expiration date of all relevant publications at which time it deletes expired publications from the location on the users hardware device.
